(19) United States
(12) Patent Application Publication
(10) Pub. No.: US 2022/0340217 A1
(43) Pub. Date: Oct. 27, 2022

(54) Articulated Wheel

(71) Applicant: Edward Valpey, Gilford, NH (US)

(72) Inventor: Edward Valpey, Gilford, NH (US)

(21) Appl. No.: 17/710,667

(22) Filed: Mar. 31, 2022

Related U.S. Application Data
(60) Provisional application No. 63/177,986, filed on Apr. 22, 2021.

(51) Int. Cl. B62D 55/065; B62D 55/14; B62D 55/10; B62D 55/20; B60K 7/00; B62D 55/108; B62K 17/00; B62K 21/00

(52) U.S. Cl. CPC B62D 55/065; B62D 55/14; B62D 55/10; B62D 55/20; B60K 7/0007; B62D 55/1086; B62K 17/00; B62K 21/00

(57) ABSTRACT

A rugged and compact articulated wheel with at least two hubs, and wheeled vehicles that include one or more of such articulated wheels.

### CLAIM OF PRIORITY

This application claims the benefit of priority of U.S. Provisional Patent Application Ser. No. 63/177,986, filed on Apr. 22, 2021.

### FIELD OF THE INVENTION

The present invention relates generally to wheels and specifically to non-traditional, articulated wheels.

### BACKGROUND

“There's no need to reinvent the wheel.” This adage is actually debatable. While it is undeniable that the invention of this simple machine was a pivotal step in the history of mankind, millennia later, we have some new considerations. Today, for example, storage demands require compact structures. Large wheels do not fold into a very compact size. Referring to FIG. 1, a prior art folding bicycle 64 with traditional wheels 62 is provided. Every component of the bicycle 64 can be cleverly contorted into a relatively small space except for the wheels 62. Their large size cannot be reduced without compromising their function, so the wheels 62 require the majority of the space of the bike 64 when folded. Vehicles with smaller wheels also exist. Referring to FIG. 2, a prior art foldable scooter 66 with traditional wheels 62 is provided. While this vehicle 66 will be quite compact when folded, and its wheels 62 will take up little space, the vehicle 66 itself is likely impractical on anything other than very smooth surfaces.

Traditional wheels 62 also diminish the functionality of some vehicles. FIG. 3, for example, provides a prior art mobility chair 68 using traditional wheels 62. While this mobility chair 68 is capable of rolling over rough terrain, it would be prohibitively unstable and impossible to steer. In this case, therefore, the large traditional wheels 62 may provide the ability to roll over rough terrain but also cause instability and steering issues.

Now referring to FIGS. 4a and 4b, a focus on prior art wheels 62 similar to those on the vehicles 64, 66 depicted in FIGS. 1 and 2 is provided. Note that in FIG. 4a, each wheel 62 needs to get over a rock and in FIG. 4b, each wheel 62 needs to get over a round obstacle. In either case, in order to climb over the obstacle, the smaller wheel 62 must accelerate the mass of the vehicle using the wheel 62 more quickly and at a steeper angle (as depicted by the arrows in FIG. 4b). This is why smaller wheels 62 are less efficient over rough terrain. Specifically, the focus is on the wheels' 62 interaction with the surface 17 over which the wheels 62 travel. Notably, at any given moment, at least 80% of the tread of the wheels 62 is doing little more than traveling through space. Only a relatively small working section 60 (shown as an arc section of larger wheel 62 in FIG. 4a) is actually moving across surface 17 at any given time. While performance of various wheels 62 will vary significantly based on size, materials, and other factors, the critical differences occur in the small area of the working section 60. There is a need to harness this contact area or working section 60 of a wheel 62 to create a stable, compact, and utilitarian wheel that may be used on any wheeled vehicle.

### SUMMARY OF THE INVENTION

The present invention is a wheel, a bicycle, a mobility chair, a dolly (such as a boat dolly), and a metal-detecting robot. The articulated wheel of the present invention is designed to maximize contact radius while minimizing overall size. The present invention was originally conceived as a means for creating a foldable bike that would be practical to ride on rough surfaces, but also truly compact when folded.

The wheel of the present invention is an elliptical, continuous loop of connected segments that form an inner and outer surface. A slit separation separates adjacent pairs of segments, where the slit extends from near the inner surface all the way through the outer surface. At least first and second hubs are disposed within the interior of the wheel, i.e., within the inner surface. At least one wheel rail extends between the centers of the first and second hubs. The connected segments provide the articulation of the wheel so that when the wheel straightens, the segments bind to form a rigid shape, and the angle between the segments determines the radius of the wheel.

When segments contact squarely on their flat surfaces, the wheel is immediately rigid. When segments contact at an angle, the wheel has some initial flexibility. Sections of the loop may be radiused to eliminate stress risers. The wheel maintains its elliptical shape as it rolls over obstacles. As such, it acts in the same way as a conventional tire of the same radius but takes up much less space. Conventional tracks, on the other hand, conform to some extent to such obstacles. Structural components of the wheel (discussed in detail below) allow the wheel to bind into a rigid shape. That the wheel of the present invention can bind into a rigid shape is a key differentiator between the wheel of the present invention and a conventional track. The rigid structure also eliminates the need for internal support (such as bogey wheels, although they may be included, as discussed below), thereby creating room within the loop for suspension, linear actuators, and/or other useful accessories (examples of which are also discussed below).

The wheel of the present invention also differs from a conventional track in that is has point of contact and generates camber thrust. The slit separations between the segments, guided by the first and second hubs, generate the elliptical shape of the wheel. This elliptical shape allows for the point contact and camber thrust generation. The elliptical shape is therefore a key structural aspect of the present invention wheel, especially as compared to the shape of a conventional track, whose tops and bottoms are typically parallel. As used herein, the term “elliptical” has its classic meaning of a conic section with a major and minor axis. As measured perpendicularly down and up from the major axis, no two points on the loop are as far from one another as the extremes of the minor axis. As measured perpendicularly right and left from the minor axis, no two points on the loop are as far from one another as the extremes of the major axis. The continuous loop also has a cross-sectional curvature that, combined with the elliptical shape of the loop, allows the wheel to have a small, oval-shaped contact patch, which makes the wheel easy to turn, as opposed to the rectangular contact patch that occurs with a conventional track. The cross-sectional curvature is visible if one were to cut through the loop at any point. The cross section that would be visible of the outer surface would be curved. The cross-section curvature also facilitates the camber thrust generation mentioned above.

There are several means for connecting the segments into the loop. The simplest means is a solid rubber loop that forms the inner surface. Another means is chain connectors, where each segment includes a bar and corresponding holes so that the bar of one segment will extend through the corresponding holes of an adjacent segment. A third means is sliding connectors, where each segment has two ridges that form a moat between them, so that when the segments are connected into the continuous loop, the moat runs the entire length of the inner surface. Each ridge on each segment has a single flange on one side and a double flange on the other side. The two single flanges on the two ridges of a segment are inserted into the two double flanges on the ridges of an adjacent segment and secured in place. With both the chain connectors and the slide connectors, adjacent pairs of segments are connected until the continuous loop of segments is formed. One of at least ordinary skill in the art will recognize that there are many ways in which the segments may be connected into the loop. Each of these ways are considered to be within the scope of the present invention.

In some embodiments, especially those in which the wheel is made of a substance with a low durometer, such as rubber or plastic, each segment may include a rigid insert that helps to maintain the desired wheel radius. It is preferred that the rigid inserts be molded into the segments, but other art-recognized methods of incorporating the rigid inserts into the segments may also be employed. So as to disambiguate the term “insert,” as used herein, the term “rigid insert” will only refer to an insert used as described above with a segment. The rigid inserts may be made of any material that has a higher durometer than the segment that it fortifies. Aluminum may be used, for example, but it is preferred that the rigid inserts be made of the same material as the continuous loop of segments, but with a higher durometer. A typical bicycle tire has a hardness of approximately 65 on the Shore A Hardness Scale, but this may be too soft for the wheel of the present invention to maintain its shape. Rigid inserts with a hardness of at least 75 on the Shore D Hardness Scale (approximately the hardness of a hardhat) would improve the rigidity of the wheel while allowing for a more traditional, softer material for the continuous loop.

At least first and second hubs are disposed within the interior of the wheel, or within the inner surface. At least one wheel rail extends between the centers of the first and second hubs. It is preferred that two wheel rails are included on either side of the hubs. There will be some amount of outward tension on the wheel rails, so if only one wheel rail is fixed on one side, there may be a tendency to deflect. The wheel rails may include means for adjusting tension between two wheel rails, such a cam tensioner. A single wheel rail may be the preferred option for lightly loaded applications, however. An example where a single wheel rail is preferred is provided below with reference to the metal-detecting robot of the present invention. The hubs may include indents that mechanically interact with protrusions from the inner surface of the loop. In some embodiments, a third hub is included between the first and second hubs and the wheel rail connects the third hub center between the first and second hub centers. A fork is preferably included, where the fork has two arms, one of which is connected to one wheel rail and one of which is connected to the other wheel rail, and a bridge that connects the two arms outside of the interior of the wheel. Shocks, such as coilover shocks, may be integrated between and connected to the arms of the fork and the wheel rails.

The wheel rails may be straight bars or may be more complicated structures that allow for attachment of multiple components and/or also provide bracing for structural integrity. In some embodiments, rather than an idler or drive wheel, the first hub may be a hub motor, which could be wired to provide dynamic braking. With the dynamic brake, or rheostatic brake, the motor wiring is switched to make the motor a generator, creating rotational resistance. Excess heat is absorbed by a resistor or resistors. In some embodiments, the second hub could serve also as a drum brake or could incorporate a “V” OR disc brake. A “V” brake that may be used with the present invention may be, for example, those sold under the brand name SHIMANO BRT-4000. A disc brake that may be used with the present invention may be, for example, those sold under the brand name RUJOI. With a disc brake system, a caliper may house the brake pads and pistons. Cantilever brakes may also be used but may not be preferred due to their greater width. A mechanical brake may be added.

At least one bogey wheel may be integrated to support heavy loads or provide lateral support. Multiple bogey wheels may be employed as needed. As an alternative to shocks as described above, a rubber torsion spring may be integrated in mechanical communication with the hub motor. A linear inner actuator may then be incorporated in mechanical communication with both the rubber torsion spring and the wheel rails. The inner actuator allows for changes in ride height and in approach angle. Rotating the rigid portion of the wheel forward and up allows the wheel to meet taller obstacles at a more advantageous angle. This is illustrated by comparing FIGS. 6l and 6m.

Wheel structure and tread design may vary according to application. The segments may, for example, have a metal structure, similar to a roller chain, with over-molded tread. This option is particularly conducive to connecting the segments through chain connectors, as described above. The wheel may have a tread profile similar to that of a fat tire bicycle. The internal structure of such a wheel may be formed by creating a molding over brittle foam inserts and then breaking the inserts out after curing. One of ordinary skill in the art will recognize that there are many possible variations on the structure and tread of the wheel of the present invention. Each of these variations is considered to be within the scope of the present invention.

The bicycle of the present invention includes two wheels of the present invention. The wheels may be any of the embodiments described above. The bicycle of the present invention may have full sized dimensions for use, but be foldable into a very compact space.

The mobility chair of the present invention includes four wheels of the present invention. The wheels may be any of the embodiments described above. The clearance provided by the wheels of the present invention allow for the seat of the mobility chair to articulate. The seat articulation allows the mobility chair to safely transport its occupant over terrain that is unlevel in any direction, as the seat articulates to keep the center of gravity better centered within the four contact patches of the wheels. The mobility chair has four wheels extending from each corner of a base. The base includes at least the wheels; a steering mechanism housed in a housing; and a frame connecting the other components of the base. The mobility chair also includes an upper portion that extends above the base. The upper portion includes the seat, at least one battery, and at least one upper actuator. The upper actuators are connected to the seat and the frame of the base, and keep the seat level or as level as possible. The steering mechanism housed within the housing preferably includes a linear steering actuator, a synchronous belt, and logarithmic spiral gears. This steering mechanism provides superior control over standard differential steering with free-swiveling rear wheels. A second steering mechanism may be placed in the front as well, making the steering either front-wheel-steer or four-wheel steer. Four-wheel steering is preferred and may use conventional steering linkage. The two-wheel-steering version would require the synchronous belt for added travel and increased Ackermann.

The dolly of the present invention includes at least two wheels of the present invention connected by an axle. While the wheels may be any of the embodiments described above, it is preferred that the dolly wheels include a third hub that is larger than the first and second hubs, so as to provide height to the dolly. The sliding connectors are the preferred means for connecting the segments of the wheels of the dolly. The first, second, and third hubs use the moat formed by the sliding connectors as a track within the inner surface of the loop. Larger dollies with at least a front wheel and two rear wheels connected by an axle may be used to launch larger watercraft.

The metal-detecting robot of the present invention preferably includes at least two wheels of the present invention and at least one metal detector. The metal-detecting robot also includes a bridge between the two wheels. As mentioned above, the metal-detecting robot is an example of a lightly loaded application, where single wheel rails on each wheel are sufficient. The bridge is connected between the two single wheel rails. In one embodiment of the metal-detecting robot, the metal detector is incorporated into or supported by the bridge and therefore disposed between the two wheels of the present invention. This metal detector would detect metal underneath the bridge and between the wheels. In another embodiment of the metal-detecting robot, a rotating extension is affixed to the bridge and extends outward on either side of the bridge and the wheels and a metal detector is attached to each end of the extension. These metal detectors would detect metal in a circular path on all sides of the robot.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a side view of a prior art foldable bicycle in a folded configuration.

FIG. 2 is a side view of a prior art foldable scooter in use.

FIG. 3 is a perspective view of a prior art mobility chair.

FIG. 4a is a side view of prior art wheels on a surface.

FIG. 4b is an alternate side view of prior art wheels on a surface.

FIG. 4c is a section of FIG. 4a with the prior art wheels removed.

FIG. 5a is an articulated working section of a wheel of the present invention.

FIG. 5b is a perspective view of a wheel of the present invention.

FIG. 5c is a detailed view of articulated segments of the wheel of the present invention.

FIG. 5d is a perspective view of articulated segments including rigid inserts.

FIG. 5e is a cross sectional view of a segment at the point of the arrow in FIG. 5b.

FIGS. 6a-6o are side or perspective views of various embodiments of the wheel of the present invention.

FIG. 7a is a detailed view of a rubber torsion spring, as shown in FIGS. 6j-6o.

FIG. 7b is a detailed view of the link connectors used to form the loop in the wheel of FIG. 6m.

FIGS. 7c and 7d are perspective views of a tensioning mechanism.

FIGS. 8a-8c are various side views of a bicycle of the present invention.

FIGS. 9a-9g are various views of a mobility vehicle of the present invention.

FIG. 10 is a detailed view of some components of the mobility vehicle of the present invention.

FIGS. 11a-11d are views of steering mechanisms of the mobility chair of the present invention.

FIGS. 11e-11g are perspective views of the base of the mobility chair of the present invention.

FIG. 12 is a side view of a dolly of the present invention.

FIGS. 13a and 13b are detailed perspective views of the wheel of the dolly shown in FIG. 12.

FIG. 13c is a perspective illustration of one method of securing together flanges similar to those shown in FIG. 13b

FIGS. 14a and 14b are side and perspective views of another embodiment of a dolly of the present invention, respectively.

FIG. 15 is a detailed perspective view of the wheel of the dolly shown in FIGS. 14a and 14b.

FIGS. 16a and 16b are perspective views of two embodiments of the metal-detecting robot of the present invention.

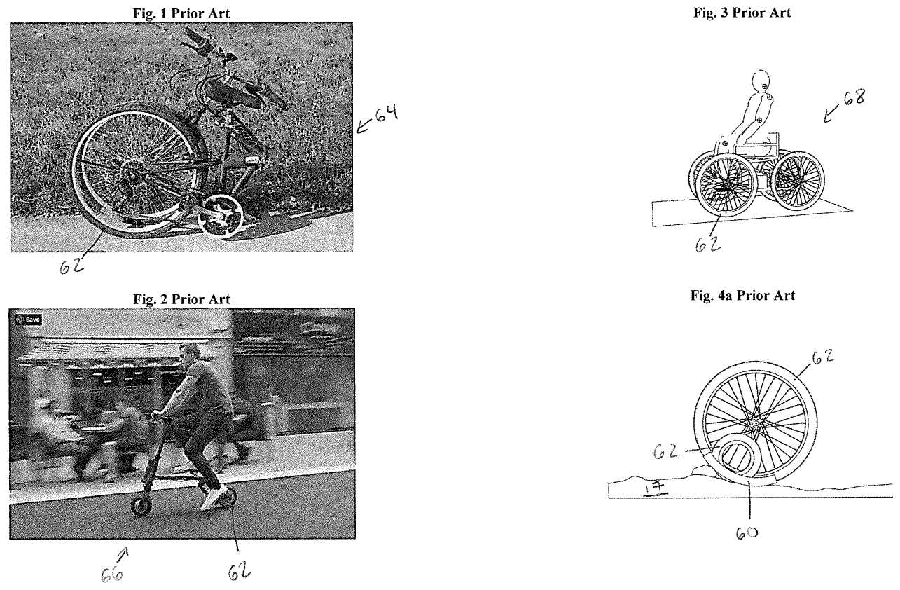

### DETAILED DESCRIPTION

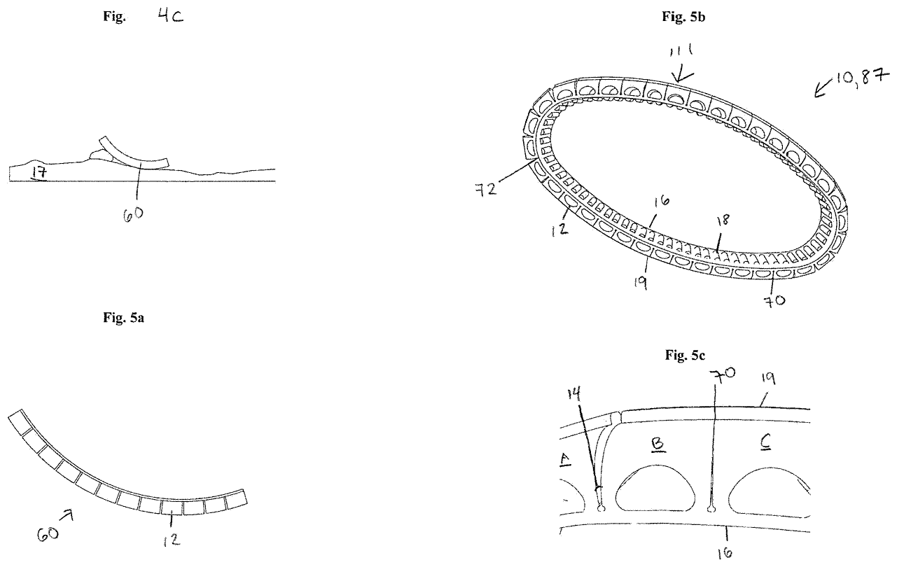

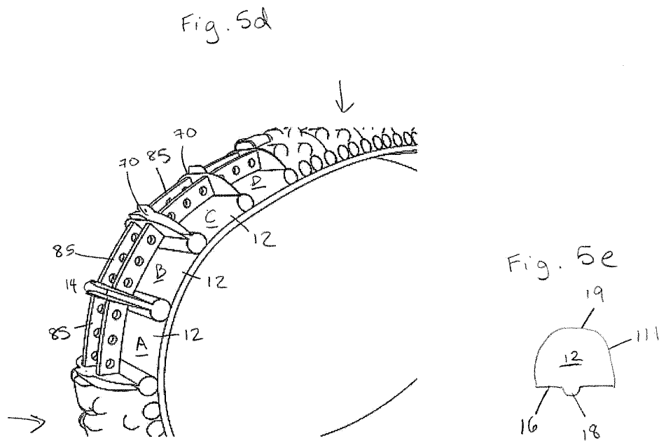

FIG. 4c is the same as FIG. 4a except that prior art wheels 62 have been removed, leaving only working section 60. Working section 60 is the part of a wheel that actually has contact with the surface 17 beneath it, so it is the part that is actually helping a vehicle to which the wheel is connected move along that surface 17. The present invention focuses on this all-important working section 60. Wheel 10 (as shown in FIG. 5b, for example) maintains the shape and integrity of this critical portion of a prior art wheel 62, while eliminating the rest.

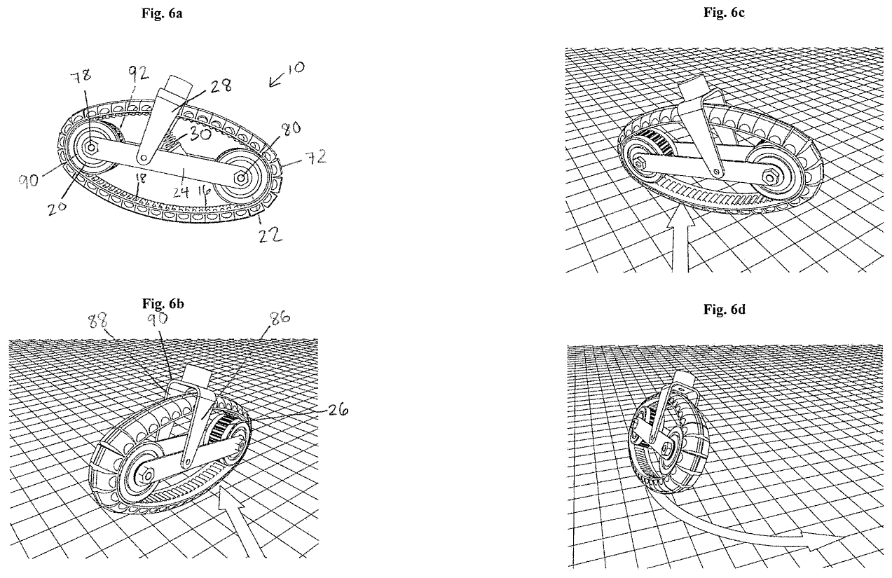

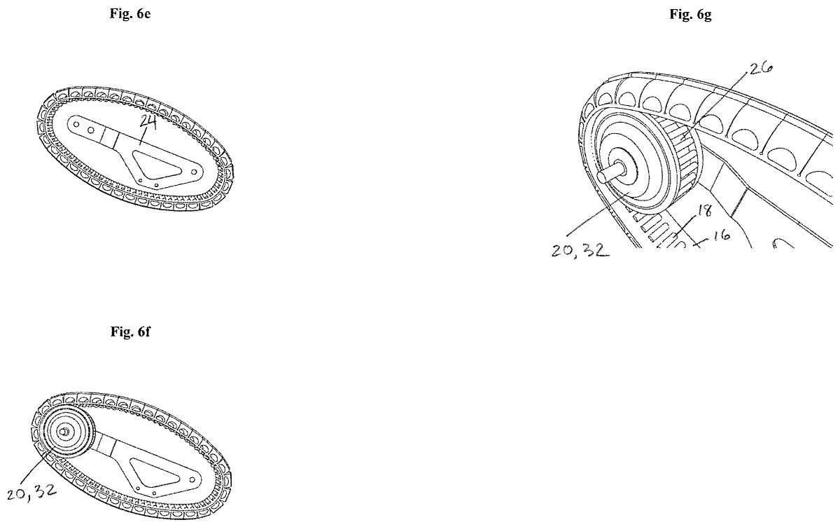

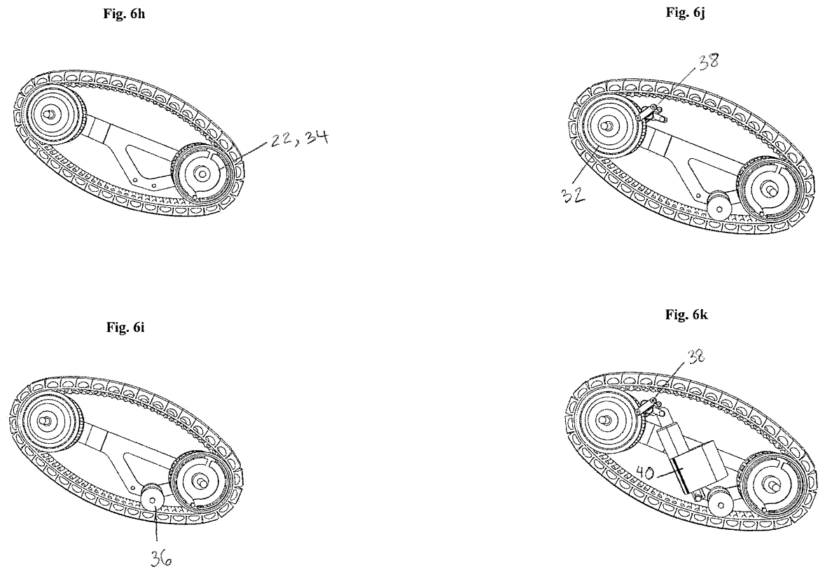

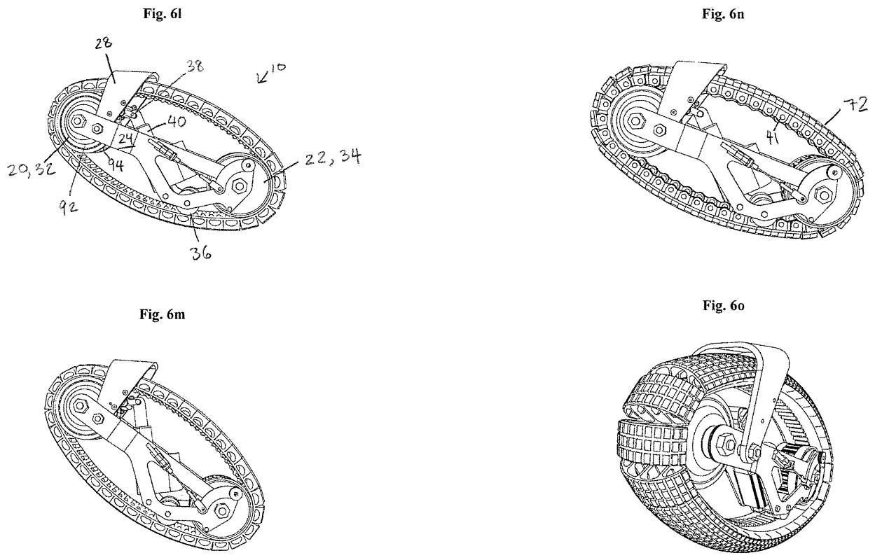

Now referring to FIGS. 5a-5c, aspects of wheel 10 of the present invention are provided. FIG. 5a shows working section 60 with individual segments 12. FIG. 5b is a perspective of a wheel 10 of the present invention. Wheel 10 has continuous articulated segments 12 to form continuous loop 72 with rigid elliptical shape 87. This loop 72 forms an inner surface 16 and an outer surface 19. Inner surface 16 includes protrusions 18, which will engage with hubs 20, 22, as described below with reference to FIG. 6a, for example. Protrusions 18 facilitate stability when a bogey wheel is used, such as bogey wheel 36, as shown in FIG. 6i, for example. FIG. 5b shows a molded rubber or polyurethane wheel 10 with fiber reinforced belting. With the segmentation, and the elimination of the interior half of a traditional wheel 62, wheel 10 can bend around tighter radii. When segments 12 contact squarely on their flat surfaces, the wheel 10 is immediately rigid. When segments 12 contact at an angle, the wheel 10 has some initial flexibility. Referring back to the small and large prior art wheels 62 shown in FIGS. 4a and 4b, for examples, wheel 10 has the physical size of the small wheel 62 but the rolling efficiency of the large wheel 62. In other words, wheel 10 would approach an obstacle, such as that shown in FIG. 4b at the less steep angle shown in FIG. 4b, like the large wheel 62, but wheel 10 has the physical size of the small wheel 62. The arrow for cross-sectional curvature 111 indicates where the cross sectional view shown in FIG. 5e is taken.

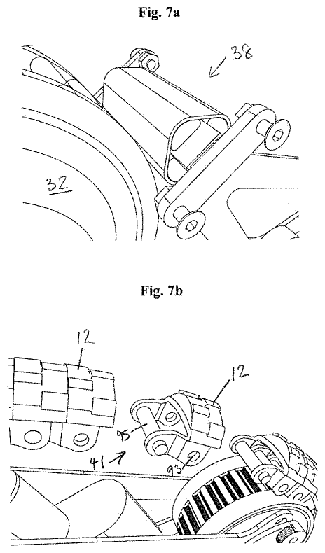

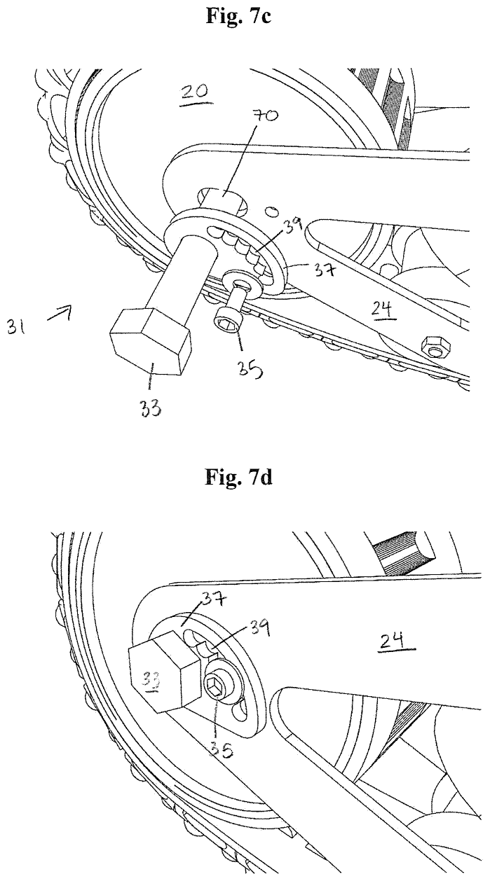

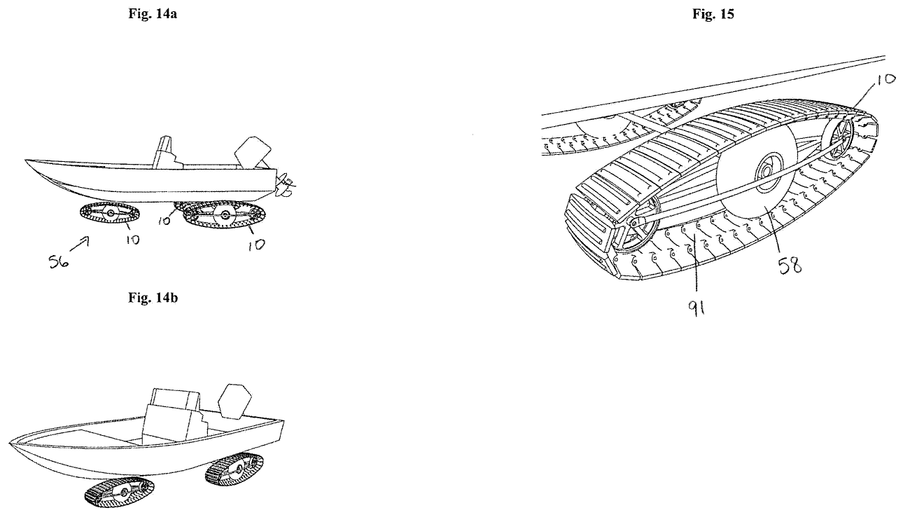

FIG. 5c provides a close up of three segments 12, labeled “A,” “B,” and “C.” As wheel 10 straightens, segments 12 bind to form a rigid shape, as shown between B and C, for example. The angle 14, shown between A and B, determines the radius of wheel 10. As used herein, the term “adjacent” segments or “adjacent pairs” of segments uses the common meaning “adjacent” and refers to segments that are right next to one another, such as segments A and B or B and C. Adjacent pairs of segments 12 are separated by a slit separation 70 that extends from proximate to the inner surface 16, all the way through the outer surface 19. For the avoidance of doubt, this means that slit separation 70 extends almost to inner surface 16, but not through it, so that one side of the slit separation 70 is near or proximate to inner surface 16. Slit separation 70 does extend all the way through outer surface 19, however. This slit separation 70 allows for the angle 14. The connection of segments 12 at inner surface 16 is simply by a strong, smooth rubber loop. Other types of connection of segments 12 are described below with regard to FIGS. 7b and 13b, for examples.

Now referring to FIG. 5d, a perspective view of segments 12 with rigid inserts 85 is provided. When continuous loop 72 and segments 12 are made of a material with a low durometer, such as rubber or plastic, each segment 12 may include a rigid insert 85 that helps to maintain the desired wheel radius. It is preferred that the rigid inserts 85 be molded into the segments, but other art-recognized methods of incorporating the rigid inserts into the segments may also be employed. In FIG. 5d, it is understood that the visible rigid inserts 85 would not typically be visible and would be encased in the remainder of the segments 12, as shown in the sections indicated with arrows. The remainder of segments 12 that would encase rigid inserts 85 is eliminated in this view so as the illustrate how the rigid inserts 85 may be incorporated into the segments 12. The rigid inserts 85 may be made of any material that has a higher durometer than the segment that it fortifies. Aluminum may be used, for example, but it is preferred that the rigid inserts 85 be made of the same material as the segments 12, but with a higher durometer. A typical bicycle tire has a hardness of approximately 65 on the Shore A Hardness Scale, but this may be too soft for the wheel 10 of the present invention to maintain its shape. Rigid inserts 85 with a hardness of at least 75 on the Shore D Hardness Scale (approximately the hardness of a hardhat) would improve the rigidity of the wheel 10 while allowing for a more traditional, softer material for the continuous loop 72 and the remainder of the segments 12. As shown in FIG. 5c, segments A-D are separated by slit separations 70 with varying angles 14 between the segments 12.

The slit separation 70 between the segments 12 allows for the characteristic elliptical shape of wheel 10. Angle 14 between segments 12 may be relatively large toward the extremes of the major axis of the elliptical loop 72, as shown, for example, in FIG. 6o. Moving toward the extremes of the minor axis of the elliptical loop 72, angle 14 will be 0° or approach 0°.

Now referring to FIG. 5e, a cross sectional view of segment 12 at the point indicated by the arrow in FIG. 5b is provided. Segment 12 and loop 72 have cross-sectional curvature 111 that, combined with elliptical shape 87, allows for the oval-shaped contact patch. The cross-sectional curvature 111 is expressed in outer surface 19 of segment 12. Ridge 18 is visible extending from inner surface 16.

Now referring to FIGS. 6a-6d, additional features of wheel 10 are provided. Wheel 10 includes at least first and second hubs 20, 22, with at least one wheel rail 24 extending between the first and second hub centers 78, 80. There are preferably two wheel rails 24 on first and second sides 92, 94 of hubs 20, 22. A fork 28 has first and second arms 86, 88 that are connected to and extend upward from the wheel rails 24. A fork bridge 90, which is outside of the loop 72 connects the sides of first and second arms 86, 88 that are not connected to wheel rails 24. Coilover shocks 30 are located between the wheel rails 24 and the first and second arms 86, 88 of fork 28 and connected to the wheel rails 24 and arms 86, 88. As shown more clearly in FIG. 6g, hubs 20, 22 have indents 26 that engage with protrusions 18 on inner surface 16.

In addition to binding into a rigid shape, wheel 10 differs from a conventional track in other ways. Two of the most significant are that wheel 10 has point contact and generates camber thrust. A conventional track has a contact patch that is quite large and rectangular, making it difficult to turn. Cross-section curvature 111 allows segmented wheel 10, on the other hand, to have a small, oval-shaped contact patch, which makes wheel 10 easy to turn. The block arrows in FIGS. 6b and 6c indicate two different point contacts. The curved arrow in FIG. 6c indicates camber thrust, which is also facilitated by cross-section curvature 111.

The wheel 10 shown in FIGS. 6a-6d is a very simple embodiment of the present invention. Wheel 10 has several embodiments that may include additional components, however. FIGS. 6e-6m provide an example of an alternate embodiment of wheel 10. FIGS. 6e-6k indicate components within loop 72 step by step before providing the entire wheel 10 in FIGS. 6l and 6m. As shown in FIG. 6e, wheel rail 24 may take many forms besides a straight rail 24, as shown in FIGS. 6a-6d. This wheel rail 24 has additional arms extending off of the straight portion to allow for connection of additional components and includes more screw holes for the same. So as to more clearly illustrate the various components within loop 72, only wheel rail 24 that would be attached to the far side 94 of hubs 20, 22 is shown in FIGS. 6e-6k. In FIG. 6f, first hub 20 is a hub motor 32. This is as opposed to wheel 10 as shown in FIGS. 6a-6d, which was an idler or drive wheel. FIG. 6g shows indents 26 on first hub 20/hub motor 32, which engage with protrusions 18 on inner surface 16 of loop 72. In FIG. 6h, second hub 22 is drum brake 34. “V,” disc, or motor brakes may also be used for second hub 22. In FIG. 6i, bogey wheel 36 is integrated to support heavy loads or provide lateral support. Although only one bogey wheel 36 is shown, it is understood that there is a preference for two bogey wheels 36 for exceptional lateral support. In FIG. 6j, coilover shocks 30, as shown in FIG. 6a, are replaced by rubber torsion springs 38. The rubber torsion springs 38 mechanically engage with hub motor 32. A detailed view of rubber torsion spring 38 is provided below in FIG. 7a. In FIG. 6k, inner actuator 40, which is a linear actuator, is shown engaged with rubber torsion springs 38, again as an alternative to traditional spring shocks.

Now referring to FIGS. 6l and 6m, the entire wheel 10 including each component introduced in FIGS. 6e-6k is provided. Namely, the first hub 20 is hub motor 32; the second hub 22, is drum brake 34; wheel rails 24 are disposed on both of the near and far sides 92, 94 of hubs 20, 22; fork 28 connects wheels rails 24; bogey wheel 36 is included between wheel rails 24; and rubber torsion spring 38 in mechanical communication with inner actuator 40 replace traditional shocks. Inner actuator 40 allows for changes in ride height. Comparing the positions of rubber torsion springe 38 and inner actuator 40 in FIGS. 6l and 6m also shows that inner actuator 40 also, and importantly, allows for changes in approach angle. Note that a standard dust/debris cover is omitted for the sake of illustrating other components, but understood to be included in preferred embodiments of wheel 10.

A standard wheel structure and tread design are provided in wheels 10 as shown in FIGS. 6a-6m. Other structures and designs may be incorporated according to application, however. In FIG. 6n, for example, the structure of loop 72 is formed by connecting segments 12 with chain connectors 41, shown in more detail in FIG. 7b. In FIG. 6o, for another example, wheel 10 has a tread profile similar to that of a fat bike. Fat bikes are characterized by oversized tires designed for low ground pressure to allow riding on soft, unstable terrain, such as snow, sand, bogs, and mud. The internal structure of the specific wheel 10 shown in FIG. 6o was created by molding over brittle foam inserts, which were broken out of the wheel after fully curing.

Now referring to FIG. 7a, a perspective detailed view of rubber torsion spring 38 and its interaction with hub motor 32 is provided. Now referring to FIG. 7b, a perspective detailed view of chain connectors 41, as used in the wheel 10 shown in FIG. 6n is provided. Each segment 12 includes a chain connector 41. The bar 95 of a chain connector 41 of one segment 12 will extend through the corresponding holes 93 on an adjacent segment 12. This is a metal structure, similar to a roller chain, with over-molded tread. It can provide greater strength and potentially greater efficiency of wheel 10.

Now referring to FIGS. 7c and 7d, perspective views of a tensioning mechanism 31 are provided. In FIG. 7c, the components of tensioning mechanism 31 are separated for illustration. In FIG. 7d, tensioning mechanism 31 is shown in place. Tensioning mechanism 31 allows for tension adjustment between wheel rails 24. Tensioning mechanism 31 includes at least large bolt 33, small bolt 35, and plate 37 with settings 39. Large bolt 33 acts as an axle and extends through plate 37, wheel rail 24, first hub 20 at first hub center 70, and wheel rail 24 on the far side of the view. Wheel rail 24 is slotted where large bolt 33 extends through, allowing movement of the wheel parallel to the wheel rail 24, but not perpendicular. Small bolt 35 is placed through one of the settings 39 in plate 37 and through wheel rail 24, but does not extend further. The setting 39 through which small bolt 35 is positioned will determine the tension. It is understood that tensioning mechanism 31 shown herein is merely exemplary and other types of tensioning mechanisms may be substituted.

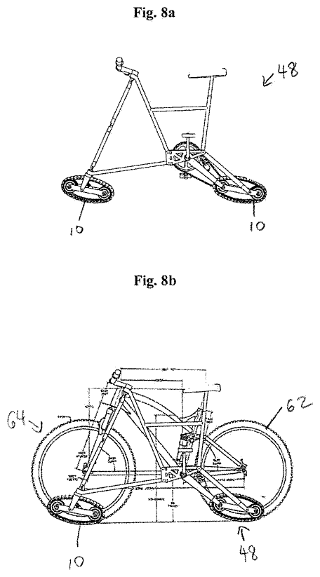

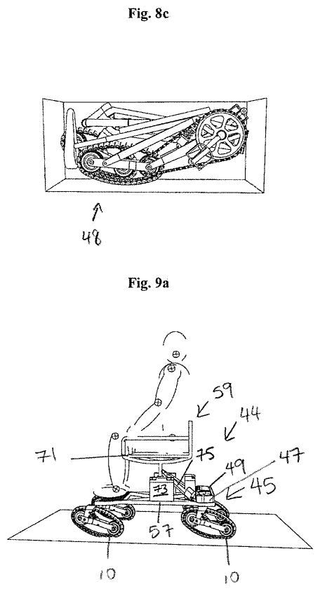

Wheel 10 of the present invention may be used advantageously in many wheeled vehicles. A few examples are provided herein. Referring to FIGS. 8a-8c, for example, bicycle 48 of the present invention is provided. Bicycle 48 has two wheels 10 of the present invention. The wheels 10 included in bicycle 48 may be any embodiments of wheel 10 described herein. FIG. 8b shows bicycle 48 superimposed over a prior art bicycle 64 with traditional wheels 62. Note that bicycle 48 has the critical dimensions of a full sized adult bicycle. The bicycle 48 is foldable and may be folded into a much smaller space than a prior art bicycle 64, as shown in FIG. 1a. A shown in FIG. 8c, this foldable version of bicycle 48, for example, can be checked as airline baggage. Specifically, the folded bicycle 48 has a total linear dimension of 61.75″, which is less than the 62″ maximum for airline baggage.

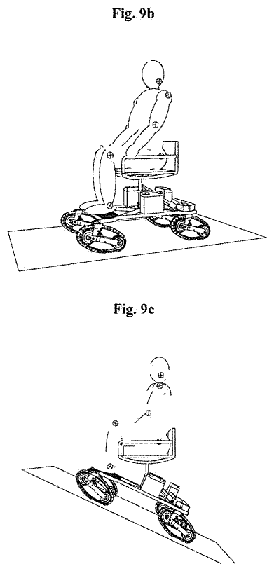

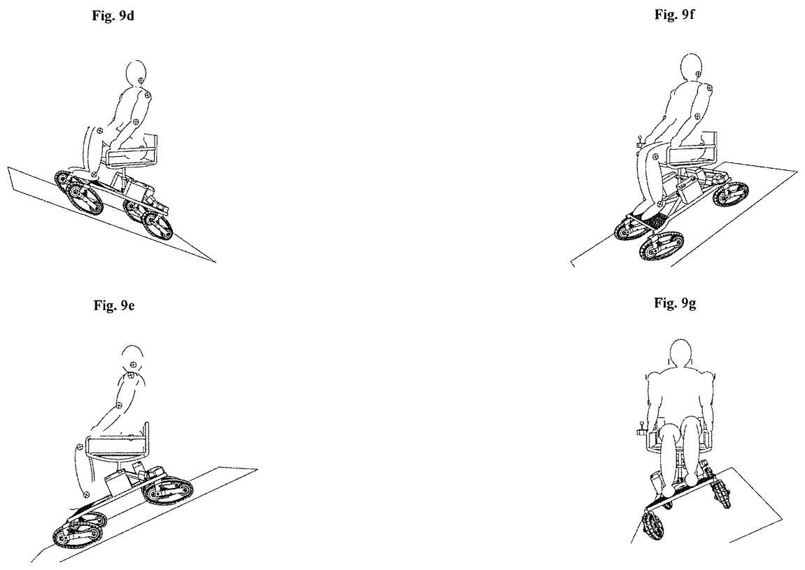

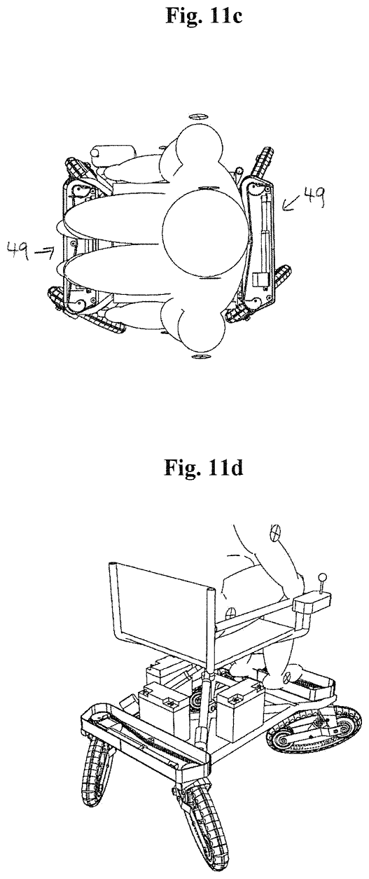

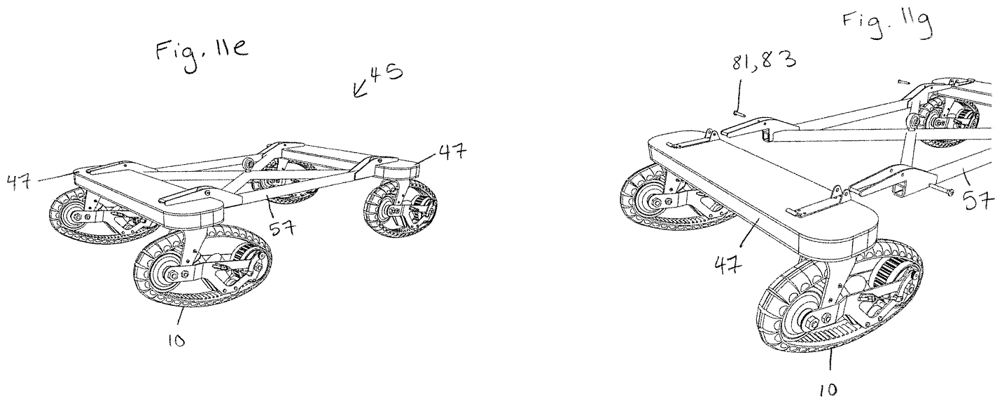

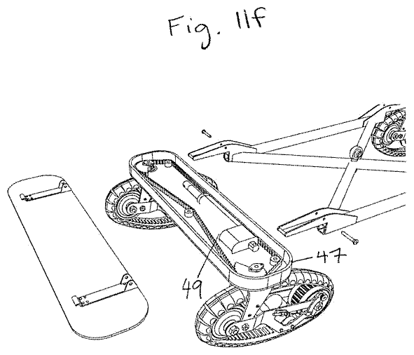

Now referring to FIGS. 9a-9g, wheel 10 may also be used with a mobility chair 44. As will be explained in detail, mobility chair 44 may be completely modular so that it may be easily broken down for travel. Mobility chair 44 has four wheels 10 extending from each corner of base 45. Base 45 includes at least wheels 10; steering mechanism 49 housed in housing 47; and frame 57. Upper portion 59 of mobility chair 44 extends above base 45 and includes seat 71, battery(ies) 73, and upper actuator(s) 75. Upper actuators 75 are connected to seat 71 and frame 57. Upper actuators 75 are linear actuators, but have a different function from inner actuator 40, discussed above with reference to FIGS. 6k-6m and from linear actuator 50, discussed below with reference to FIGS. 11a and 11b. Upper actuators 75 allow seat 71 to remain level or as level as possible as base 45 moves over inclined or bumpy terrain.

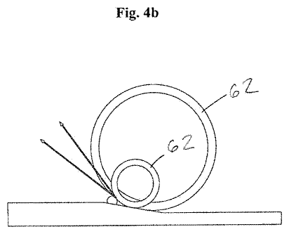

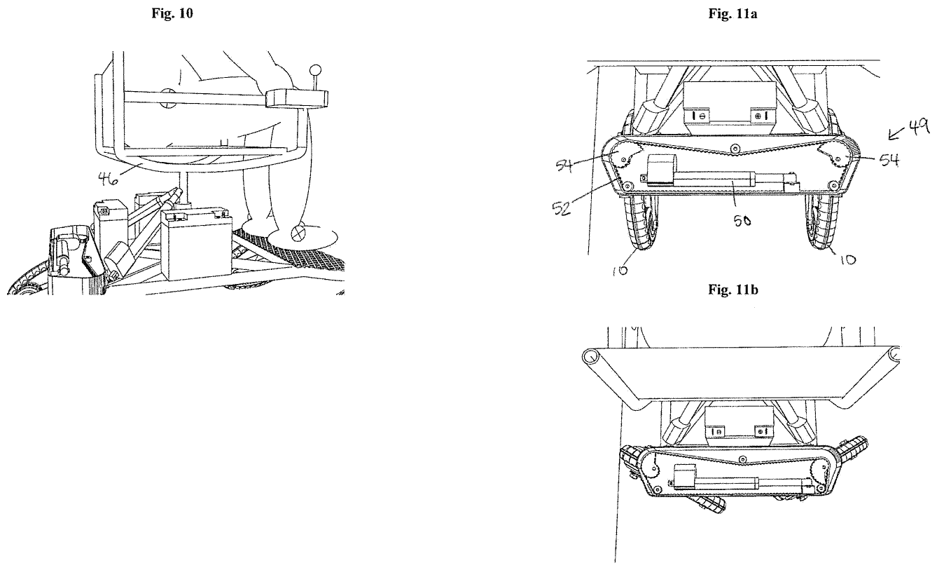

FIGS. 9a-9g illustrate the approach of mobility chair 44 over surfaces with inclines in all directions, any of which mobility chair 44 handles with ease and safety for its occupant. This is a vast difference from the prior art mobility chair 68 shown in FIG. 3, for example. Referring to FIG. 10, the clearance provided by wheels 10 allows the seat 46 to articulate to adjust to such inclines, keeping the center of gravity better centered within the four contact patches of wheels 10.

Referring to FIGS. 11a and 11b, steering mechanism 49 links rear wheels 10 to one another and to a steering actuator 50, or servo motor, utilizing a synchronous belt 52. Logarithmic spiral or eccentric gears 54 create the 60 degrees of Ackermann required. In addition, the wheels 10 may be steered with individual servo motors programmed to create the needed Ackermann.

Steering actuator 50 is also a linear actuator, like inner actuator 40, discussed above with reference to FIG. 6k, for example. They have been labeled differently herein so as to disambiguate their functions, despite any similarity in their actual structures. Differential steering with free-swiveling rear wheels is an alternative to steering mechanism 49, but has proved difficult to control. Steering mechanism 49 is preferred. FIGS. 11a and 11b show steering mechanism 49 giving mobility chair 44 front-wheel-steering. Referring to FIGS. 11c and 11d, a second steering mechanism 49 may also be incorporated in the front of mobility chair 44, for four-wheel-steering.

Now referring to FIGS. 11e-11g, perspective views of base 45 of mobility chair 44 are provided, with the upper portion 59 of mobility chair 44 not shown in order to better illustrate aspects of base 45. This upper portion 59 may be easily releasable from base 45 through any means commonly used in the art. This base 45 includes housings 47 at the front and back, indicating that this base 45 may include a second steering mechanism 49 for four-wheel-steering. It is understood, however, that it is possible that only one housing 47 holds a steering mechanism 49 and the second may house something else or nothing, but make the base aesthetically symmetrical. FIG. 11f is provided for illustrative purposes only to show that housing 47 houses steering mechanism 49, as discussed with respect to 11a, for example. In FIG. 11e, base 45 is assembled with each housing 47 closed so as to protect steering mechanism(s) 49. In this FIG. 11e, mobility chair 44 has already been partially dissembled by the separation of upper portion 59 from base 45. In FIG. 11g, base 45 is further disassembled by separating each housing 47 (including the wheels 10 attached thereto) from frame 57. Although frame 57 is shown with two parallel side bars and crossing bars therebetween, it is understood that frame 57 may take any of several forms. As shown, this disassembly is accomplished by quick-release pins 83, but it is understood that this disassembly may be accomplished by any means 81 commonly used in the art. Ultimately, through releasable electrical connections, release mechanisms such as the quick-release pins 83 shown in FIGS. 11f and 11g, and easy releases for batteries 73 and upper actuators 75, the entire mobility chair 44 is easily entirely disassembled so that it could be compressed into three or four bags. The mobility chair 44 could, therefore, be driven to airport check-in; disassembled on the spot; checked as baggage; picked up at the destination luggage carousel; reassembled on the spot; and driven away.

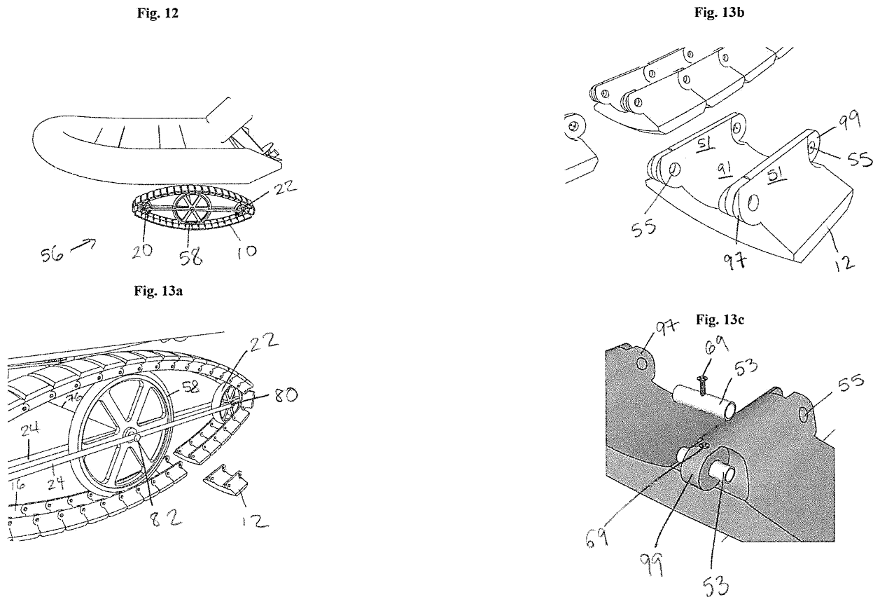

Now referring to FIG. 12, wheel 10 may also be used with a dolly 56, such as a dolly used to launch a boat. The wheels 10 for the dolly 56 might be lightweight, roto-molded HDPE and could launch a tender such as the one shown from a beach or modestly rocky shoreline. In this view, wheel 10 has a third hub 58 disposed between first and second hubs 20, 22. Referring to FIG. 13a, as with the embodiments of wheel 10 described above, wheel rails 24 are disposed on either side of hubs 20, 22 and connect first and second hub centers 78, 80. (Although cut off, it is understood that first hub 20 with first hub center 78 would be on the left of FIG. 13a.) With this wheel 10, including third hub 58, wheel rails 24 also connect third hub center 82 between first and second hub centers 78, 80. Dolly 56 would also include an axle 76 between a similar wheel 10 on the other side (not shown). Referring to FIG. 13b, a different type of connection between adjacent segments 12 is also illustrated. Each segment includes a sliding connector 84. Sliding connector 84 has two ridges 51 that form a moat 91 therebetween, where moat 91 runs the length of inner surface 16. Each ridge 51 has a single flange 99 and a double flange 97. The single flanges 99 on one side of a segment 12 are inserted between the double flanges 97 on an adjacent segment 12. Holes 55 extend through both single and double flanges 99, 97. The single flange 99 between double flanges 97 are then secured together. This may be by pinning or bolting them together, such as with a binding barrel. Referring to FIG. 13c, one means for securing them together is illustrated, showing a small section of tubing 53 that will extend through the holes 55 in double flanges 97 and single flange 99 and then screwed in place with screw. One of ordinary skill in the art will recognize that the flanges 97, 99 may be secured together in many ways and each of these ways is considered to be within the scope of the present invention.

First, second, and third hubs 20, 22, 58 are tracked in moat 91 within ridges 51. This embodiment of wheel 10 therefore may omit protrusions 18, as shown in FIG. 6g.

Now referring to FIGS. 14a and 14b, side and perspective views of a larger dolly 56 are provided. Such a larger, motorized version of dolly 56 might be used to launch larger boats. This dolly 56 has three wheels 10. Referring to FIG. 15, another embodiment wheel 10 that might be used with such a dolly 56 is provided. The tread is wider, almost akin to a tank tread. Moat 91 is also wider and third hub 58 is more robust than the version shown in FIG. 13a.

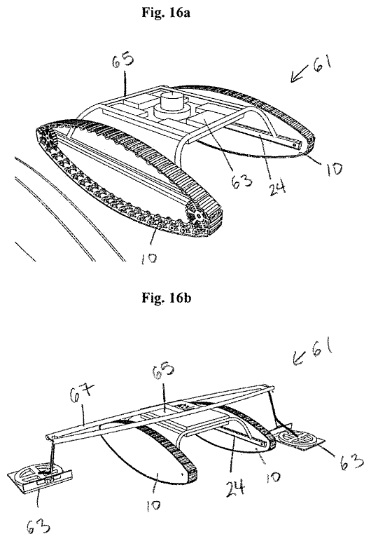

Now referring to FIGS. 16a and 16b, perspective views of two embodiments of metal-detecting robot 61 are provided. Each robot 61 has two wheels 10 of the present invention. In these embodiments, each wheel 10 includes only one inward-facing wheel rail 24. A bridge 65 connects the two wheels 10 and is connected to the inward-facing wheel rails 24 of each wheel. In FIG. 16a, the metal detector 63 is attached to the bridge 65 or is part of the bridge 65, so that metal is detected beneath the bridge 65 and between the wheels 10. In FIG. 16b, an extension 76 extends across bridge 65 and includes a metal detector 63 on either end of the extension 76, so that metal is detected on either side of the wheels 10.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

I claim:

1. An articulated wheel comprising:
an elliptical, continuous loop of a plurality of connected segments forming an inner surface and an outer surface, wherein:
said loop comprises slit separations between adjacent pairs of said plurality of connected segments; and
each of said slit separations extends from proximate to said inner surface through said outer surface;
at least first and second hubs comprising first and second hub centers, respectively, wherein said at least first and second hubs are disposed within said inner surface of said loop; and
at least one wheel rail connecting said first and second hub centers such that said first and second hubs are held in place within said inner surface.

2. The articulated wheel as claimed in claim 1, further comprising at least a third hub with a third hub center, wherein:
said at least third hub is disposed between said first and second hubs; and
said at least one wheel rail connects said third hub center to said first and second hub centers.

3. The articulated wheel as claimed in claim 1, wherein:
said at least one wheel rail is first and second wheel rails, wherein said first wheel rail connects said first and second hub centers on a first side and said second wheel rail connects said first and second hub centers on a second side; and
said articulated wheel further comprises a fork, comprising:
a first arm connected to said first wheel rail;
a second arm connected to said second wheel rail; and
a bridge connecting said first and second arms outside of said loop.

4. The articulated wheel as claimed in claim 3, further comprising coilover shocks disposed between and connected to said first and second wheel rails and connected to said fork between said first and second arms of said fork.

5. The articulated wheel as claimed in claim 3, further comprising means for adjusting tension between said first and second wheel rails.

6. The articulated wheel as claimed in claim 1, wherein at least said first hub is a hub motor.

7. The articulated wheel as claimed in claim 1, wherein at least said second hub is a brake.

8. The articulated wheel as claimed in claim 7, wherein at least said second hub is a drum brake.

9. The articulated wheel as claimed in claim 1, further comprising at least one bogey wheel.

10. The articulated wheel as claimed in claim 1, further comprising a rubber torsion spring mechanically engaged with said first hub.

11. The articulated wheel as claimed in claim 1, further comprising an inner actuator in mechanical communication with said first hub and said at least one wheel rail.

12. The articulated wheel as claimed in claim 1, wherein each of said segments comprises a bar and holes sized to accommodate said bar, such that said bar of one of said segments extends through said holes of an adjacent other of said segments thereby connecting all of said segments in series to form said loop.

13. The articulated wheel as claimed in claim 1, wherein each of said segments comprises a sliding connector and wherein:
said sliding connector comprises two ridges that form a moat therebetween, wherein each ridge comprises a single flange and a double flange and said single flange is sized and dimensioned to fit within said double flange; and
said single flange of a segment is secured between said double flange of an adjacent other of said segments, thereby connecting all of said segments in series to form said loop.

14. The articulated wheel as claimed in claim 1, wherein each of said plurality of segments comprises a rigid insert comprising a higher durometer than a remainder of each of said plurality of segments.

15. The articulated wheel as claimed in claim 1, wherein said outer surface of said loop comprises a cross-sectional curvature.

16. A mobility vehicle comprising four articulated wheels, wherein each of said articulated wheels comprises:
an elliptical, continuous loop of a plurality of connected segments forming an inner surface and an outer surface, wherein:
said loop comprises slit separations between adjacent pairs of said plurality of connected segments; and
each of said slit separations extends from proximate to said inner surface through said outer surface;
at least first and second hubs comprising first and second hub centers, respectively, wherein said at least first and second hubs are disposed within said inner surface of said loop; and
at least one wheel rail connecting said first and second hub centers such that said first and second hubs are held in place within said inner surface.

17. The mobility vehicle as claimed in claim 16, further comprising:
a base comprising:
four corners, wherein one of each of said four articulated wheels extends from each of said four corners;
a frame connecting at least said four corners; and
at least one housing that houses a steering mechanism; and
an upper portion extending up from said base, said upper portion comprising:
a seat attached to and extending up from said frame of said base;
at least one battery; and
at least one upper actuator, extending between said seat and said frame of said base, wherein said upper actuator is extendable so as to keep said seat level.

18. The mobility vehicle as claimed in claim 17, wherein said steering mechanism of said upper portion is in mechanical communication with at least two of said four articulated wheels, wherein said steering mechanism comprises:
a synchronous belt;
at least two logarithmic spiral gear disposed within said synchronous belt; and
a steering actuator.

19. The mobility vehicle as claimed in claim 17, wherein:
said at least one housing that houses a steering mechanism is two housings, each of which houses a steering mechanism; and
each of said steering mechanisms is in mechanical communication with two of said four articulated wheels.

20. The mobility vehicle as claimed in claim 19, wherein each of said steering mechanisms comprise:
a synchronous belt;
at least two logarithmic spiral gear disposed within said synchronous belt; and
a steering actuator.
